(19) United States
(12) Patent Application Publication
(10) Pub. No.: US 2025/0322291 A1
(43) Pub. Date: Oct. 16, 2025

(54) Differentiating between human-generated and AI-generated digital content

(71) Applicant: DigiCert, Inc., Lehi, UT (US)

(72) Inventor: Avesta Hojjati, Austin, TX (US)

(73) Assignee: DigiCert, Inc., Lehi, UT (US)

(21) Appl. No.: 18/633,419

(22) Filed: Apr. 11, 2024

(51) Int. Cl. G06N 20/00

(52) U.S. Cl. CPC G06N 20/00

(57) ABSTRACT

Systems and methods are provided for predicting whether digital content is generated by a human or by a machine. In one implementation, a method includes a step of receiving digital content to be tested. The method further includes a step of analyzing the digital content with respect to both a human classification model associated with a specific individual and a computer classification model associated with a specific Generative Artificial Intelligence (GenAI) engine. In addition, based on results of analyzing the digital content, the method includes a step of predicting whether credit for creating the digital content is to be assigned to the specific individual or the GenAI engine.

### FIELD OF THE DISCLOSURE

The present disclosure relates generally to computing systems and digital certification. More particularly, the present disclosure relates to systems and methods for analyzing digital content to predict whether the digital content was generated by a human or a Generative Artificial Intelligence (GenAI) engine.

### BACKGROUND

With the advent of modern day Artificial Intelligence (AI) and Machine Learning (ML) techniques, it has become difficult to distinguish between digital content that was originally created by a human and digital content that was created by a machine. As an example, digital content may take many different forms, such as computer software code, videos, photographs, artwork, Non-Fungible Tokens (NFTs), digital assets, music, news, literary works, etc. Reproducing or copying original digital content can easily lead to certain violations of plagiarism and copyright infringement. However, differentiating between human-generated data versus data generated by a Generative AI (GenAI) or other computer-based engine is becoming more of an issue with the introduction of certain Large Language Models (LLMs) and GenAI engines, such as ChatGPT. This has become a wide spread issue as 1) AI engines are capable of producing large datasets in short periods of time and 2) they are capable of using data from multiple sources. An example of a potential copy-and-paste issue is the copying of software code that has been committed to repositories (repos) where it can be difficult to tell if code has been generated by a developer or by an LLM.

### BRIEF SUMMARY

The present disclosure relates to systems and methods for predicting a source of digital content and assigning credit for creating this digital content. According to one implementation, a method includes the step of receiving digital content to be tested. The method further includes a step of analyzing the digital content with respect to both a human classification model associated with a specific individual and a computer classification model associated with a specific Generative Artificial Intelligence (GenAI) engine. Also, based on results of analyzing the digital content, the method further includes a step of predicting whether credit for creating the digital content is to be assigned to the specific individual or the GenAI engine.

According to some embodiments, the step of predicting whether credit for creating the digital content may include a step of determining whether a source of “consequential” portions of the digital content is to be credited to the specific individual or the GenAI engine. That is, irrelevant background templates and boilerplate data may be disregarded. The step of predicting may also include, in some embodiments, a step of determining “portions” (e.g., percentages, amounts, etc.) of the digital content that are credited to the specific individual and/or GenAI engine. The method may further include a step of providing an output including details of a prediction associated with the step of predicting whether credit for creating the digital content is to be assigned to the specific individual or the GenAI engine. In some embodiments, the details of the prediction may be based on the consequential portions, as well as an identification of what is considered to be consequential, plus an amount (or portion or percentage) of the credited content.

In some embodiments, the digital content described in the method may refer to software code. In this case, the step of training the human classification model may be performed, for example, by learning programming habits, styles, patterns, syntax, function generation techniques, and human-readable comments of the specific individual (e.g., programmer) from samples of software code obtained from an Integrated Development Environment (IDE) associated with the specific individual or programmer.

The human classification model may be trained, according to some implementations, with respect to a group of collaborating individuals. Also, the computer classification model may be trained with respect to a group of GenAI engines. In some embodiments, the method may further include steps of a) training a plurality of human classification models respectively associated with a plurality of individuals, and b) training a plurality of computer classification models respectively associated with a plurality of GenAI engines. Also, the method may include steps of a) training the human classification model based on one or more digital content samples verified as being created by the specific individual, and b) training the computer classification model based on one or more digital content samples verified as being created by the specific GenAI engine.

In some implementations, the method may also include steps of a) receiving a first set of label information associated with the specific individual for supervised training of the human classification model, and b) receiving a second set of label information associated with the specific GenAI engine for supervised training of the computer classification model. Also, the step of predicting whether credit for creating the digital content is to be assigned to the specific individual or the GenAI engine may include the utilization of a Machine Learning (ML) engine encoded with the human classification model and computer classification model. According to various embodiments, the digital content described herein may include videos, photographs, artwork, Non-Fungible Tokens (NFTs), digital assets, music, news, literary works, and/or other similar types of data.

In various embodiments, the present disclosure includes a) methods having the above-mentioned steps, b) processing devices configured to implement the above-mentioned steps, c) cloud services configured to implement the above-mentioned steps, and d) non-transitory computer-readable media storing instructions for programming one or more processors to execute the above-mentioned steps.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a block diagram illustrating a computing system configured to determine the source of digital content, according to various embodiments of the present disclosure.

FIG. 2 is a block diagram illustrating a Machine Learning (ML) system for predicting how credit for the creation of digital content is to be assigned, according to various embodiments.

FIG. 3 is a block diagram illustrating another ML system for predicting how credit for the creation of digital content is to be assigned, according to various embodiments.

FIG. 4 is a flow diagram illustrating a method for predicting a source of digital content and assigning credit for the creation of the digital content, according to various embodiments.

### DETAILED DESCRIPTION

Again, the present disclosure relates to systems and methods for distinguishing or differentiating between digital content (e.g., software code, literary works, music, videos, etc.) that has been created by a human and digital content that has been created by an Artificial Intelligence (AI) or Machine Learning (ML) engine. For example, using a supervised learning technique, a human classification model can be trained on samples of digital content that is verified as being generated by one or more specific individuals. Also, using another supervised learning technique, a computer classification model can be trained on other samples of digital content that is verified as being generated by one or more specific GenAI engines. Using another ML model, new digital content can be analyzed by comparing the new digital content with the human-based model and the computer-based model to determine the source of the new digital content.

### Computing System

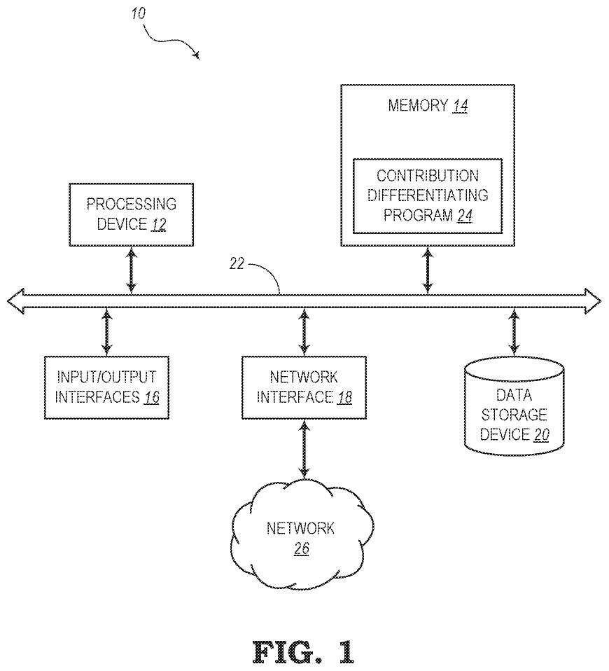

FIG. 1 is a block diagram illustrating an embodiment of a computing system 10 configured to determine the source of digital content. The computing system 10 may be a digital computer that, in terms of hardware architecture, generally includes a processing device 12, a memory 14, input/output (I/O) interfaces 16, a network interface 18, and a data storage device 20. It should be appreciated by those of ordinary skill in the art that FIG. 1 depicts the computing system 10 in an oversimplified manner, and a practical embodiment may include additional components and suitably configured processing logic to support known or conventional operating features that are not described in detail herein. The components (12, 14, 16, 18, 20) are communicatively coupled via a local bus interface 22. The local bus interface 22 may be, for example, but not limited to, one or more buses or other wired or wireless connections, as is known in the art. The local bus interface 22 may have additional elements, which are omitted for simplicity, such as controllers, buffers (caches), drivers, repeaters, and receivers, among many others, to enable communications. Further, the local bus interface 22 may include address, control, and/or data connections to enable appropriate communications among the aforementioned components.

The processing device 12 is a hardware device for executing software instructions. The processing device 12 may be any custom made or commercially available processor, a Central Processing Unit (CPU), an auxiliary processor among several processors associated with the computing system 10, a semiconductor-based microprocessor (in the form of a microchip or chipset), or generally any device for executing software instructions. When the computing system 10 is in operation, the processing device 12 is configured to execute software stored within the memory 14, to communicate data to and from the memory 14, and to generally control operations of the computing system 10 pursuant to the software instructions. The I/O interfaces 16 may be used to receive user input from and/or for providing system output to one or more devices or components.

The network interface 18 may be used to enable the computing system 10 to communicate on a network, such as the Internet. The network interface 18 may include, for example, an Ethernet card or adapter or a Wireless Local Area Network (WLAN) card or adapter. The network interface 18 may include address, control, and/or data connections to enable appropriate communications on the network. A data storage device 20 (e.g., one or more databases, data stores, etc.) may be used to store data. The data storage device 20 may include volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data storage device 20 may incorporate electronic, magnetic, optical, and/or other types of storage media. In one example, the data storage device 20 may be located internal to the computing system 10, such as, for example, an internal hard drive connected to the local bus interface 22 in the computing system 10. Additionally, in another embodiment, the data storage device 20 may be located external to the computing system 10 such as, for example, an external hard drive connected to the I/O interfaces 16 (e.g., SCSI or USB connection). In a further embodiment, the data storage device 20 may be connected to the computing system 10 through a network, such as, for example, a network-attached file server.

The memory 14 may include volatile memory elements (e.g., random access memory (RAM, such as DRAM, SRAM, SDRAM, etc.)) and/or nonvolatile memory elements (e.g., ROM, hard drive, tape, CDROM, etc.). Moreover, the memory 14 may incorporate electronic, magnetic, optical, and/or other types of storage media. Note that the memory 14 may have a distributed architecture, where various components are situated remotely from one another but can be accessed by the processing device 12. The software in memory 14 may include one or more software programs, each of which includes an ordered listing of executable instructions for implementing logical functions. The software in the memory 14 includes a suitable Operating System (O/S) and one or more programs. The O/S essentially controls the execution of other computer programs, such as the one or more programs, and provides scheduling, input-output control, file and data management, memory management, and communication control and related services. The one or more programs may be configured to implement the various processes, algorithms, methods, techniques, etc. described herein.

The computing system 10 further includes a contribution differentiating program 24 that may be implemented in any suitable combination of hardware (e.g., configured in the processing device 12) and/or software/firmware (e.g., configured in the memory 14). The contribution differentiating program 24 may be stored in any suitable non-transitory computer-readable media (e.g., the memory 14) and may include computer logic or code having instructions that enable or cause the processing device 12 to perform certain actions as discussed in the present disclosure.

For example, in general, the contribution differentiating program 24 may be configured to cause the processing device 12 to analyze new digital content and compare the new content with a human classification (or categorization) model to determine a likelihood that the content was produced by an individual or group of individuals associated with the human classification model. The human classification model may be trained on historical samples (and ongoing samples) of digital content of the individual or group to determine various habits, tendencies, or unique characteristics used to create the content. In some embodiments, the contribution differentiating program 24 may use Natural Language Processing (NLP) techniques to determine these habits, tendencies, etc. Also, the contribution differentiating program 24 may be configured to cause the processing device 12 to compare the new digital content with one or more computer-based classification models, which may be associated with one or more GenAI tools and the characteristics thereof.

Thus, by analyzing the new content with the human-based and computer-based models, the contribution differentiating program 24 is configured to determine and predict whether the new digital content was produced by a specific person, a specific GenAI engine, a combination of both, etc. Furthermore, the contribution differentiating program 24 can determine the likelihood or probability that the prediction is correct and provide a score showing the confidence level that the prediction accurately concludes the author or creator of the digital content. It may be noted that the contribution differentiating program 24 may also provide other analysis of a predicted source of the digital content as well as other outputs (e.g., displays, scores, etc.) regarding the results of the ML analysis of the new digital content.

Of note, the general architecture of the computing system 10 can define any device described herein. However, the computing system 10 is merely presented as an example architecture for illustration purposes. Other physical embodiments are contemplated, including virtual machines (VM), software containers, appliances, network devices, and the like.

In an embodiment, the various techniques described herein can be implemented via a cloud service. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. The phrase “Software as a Service” (SaaS) is sometimes used to describe application programs offered through cloud computing. A common shorthand for a provided cloud computing service (or even an aggregation of all existing cloud services) is “the cloud.”

### Examples of ML Systems for Predicting the Source of Digital Content

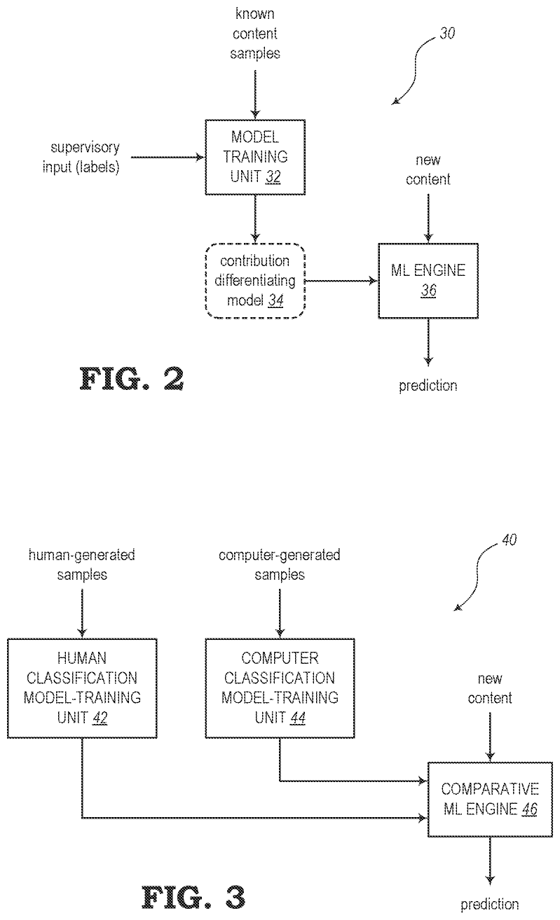

FIG. 2 is a block diagram illustrating an embodiment of an ML system 30 for predicting how credit for the creation of digital content is to be assigned. In other words, the ML system 30 is configured to determine the source of digital content and/or the source of pertinent, consequential, unique, or impactful portions of the digital content that rise above regular or known portions. For example, with respect to the digital content being computer software code, the “regular or known portions” of this digital content may include reusable software code, known code snippets, predefined code, regular copy-and-paste code, background programming templates, simple code sections, boilerplate code, standard library code, starter code, etc. that many programmers may use for regular processing or computing. Similarly, with respect to the digital content including content other than computer software code (e.g., videos, photographs, artwork, Non-Fungible Tokens (NFTs), digital assets, music, news, literary works, etc.), the digital content may include other “regular or known portions” that do not particularly distinguish the content from other content.

As shown in FIG. 2, the ML system 30 includes a model training unit 32. The model training unit 32, in this embodiment, is configured to receive known content samples, which may be obtained from various reference sources (e.g., databases, etc.). Also, the model training unit 32 is configured to receive supervised input (e.g., labels) that can be used for training. For example, the supervised input may include the true (or verified) identity of the author, creator, or contributor of the received content samples. In other words, as a sample is received, a user may enter where the sample comes from, who (or what) created the sample, when the sample was created, and other metadata of the sample. In this way, the model training unit 32 can categorize or classify the samples with respect to the author, creator, or contributor.

Based on the received content samples and corresponding supervised input, the model training unit 32 is configured to produce a contribution differentiating model 34 that represents multiple entities to which credit may be assigned for future digital content to be tested. The multiple entities may include at least one individual and at least one GenAI engine (or other LLM). The model training unit 32, in some embodiments, may be configured to create multiple contribution differentiating models 34, where each contribution differentiating model 34 may represent a single entity, in which, again, an entity may represent an individual (or group of people) or a computer-based engine. The contribution differentiating model 34 is embedded in an ML engine 36 to enable the ML engine 36 to properly distinguish between digital content created by a specific human (or specific group of people) or a specific GenAI engine. Thus, when new content is received by the ML engine 36, the ML engine 36 is configured to produce a prediction of the source of digital content.

In some embodiments, the new content may additionally be applied to the model training unit 32 (as known content samples) to further train the contribution differentiating model 34 and/or modify the model as needed to predict the author more accurately. For example, the applying of new content may involve a Reinforcement Learning (RL) procedure. Furthermore, in some embodiments, the new content and prediction may be fed back to the model training unit 32, with additional supervised information, to re-train the model as needed for fine-tuning the model by the model training unit 32.

FIG. 3 is a block diagram illustrating another embodiment of a ML system 40 for predicting how credit for the creation of digital content is to be assigned. In this embodiment, the ML system 40 includes a human classification model-training unit 42 (or multiple human classification model-training units) and a computer classification model-training unit 44 (or multiple computer classification model-training units). The human classification model-training unit 42 may be configured to receive known human-generated samples, while the computer classification model-training unit 44 may be configured to receive known computer-generated samples.

In some embodiments, the human classification model-training unit 42 may be configured to train a model for each individual (or each group of collaborating people) based on the human-generated samples associated with each of the specific individuals or groups. Also, the computer classification model-training unit 44 may be configured to train a model for each GenAI engine (e.g., model, generator, tool, LLM, Generative Pre-trained Transformer (GPT), etc.) based on the computer-generated samples associated with each of the specific GenAI engine. Again, both the human classification model-training unit 42 and computer classification model-training unit 44 may receive supervisory training input to assist with labelling the samples as human-generated and/or computer-generated.

The ML system 40, in this embodiment, further includes a comparative ML engine 46. The trained models from the human classification model-training unit 42 and computer classification model-training unit 44 can be provided to ML engine 46 for further training the comparative ML engine 46 to distinguish between human-based models and computer-based models. Thus, when the comparative ML engine 46 receives new content, it can compare this new content with the human-based models and computer-based models to differentiate between what content (or portions thereof) originates from a registered person (or group of collaborating people) and what content (or portions thereof) originates from a registered GenAI. The registering of individuals and GenAI engines may involve a Certificate Authority (CA) or other trusted entity for verifying the nature of digital content that each would normally produce. The CA may include retraining and/or RL for updating each respective model with new content as it is discovered and entered into the ML system 40. Again, the comparative ML engine 46 can compare new content with pre-trained models to predict, with a calculatable level of certainty, the source of the content in order that credit can be rightfully assigned to the actual contributing party.

### Implementation Examples of the ML Systems

The ML systems 30, 40 may use various implementation methods for obtaining an accurate prediction of digital content authorship. In one example, the ML systems 30, 40 may train multiple models based on past code samples from developers and from GenAI sources. The ML systems 30, 40 can then use the multiple models to determine if a new code sample was from the developer or from GenAI. The ML systems 30, 40 may use the models to determine if a new code sample originates from a developer or from a GenAI source by a combination of classification techniques and joining models.

One approach may include:

Step 1—Preprocessing code samples, which may further include
a) Normalization—Standardize the formatting of all code samples (e.g., indentation, spacing, etc.) to minimize stylistic differences that are not substantive, and
b) Feature Extraction—Convert code samples into a format suitable for ML models. This could involve tokenization, extracting syntactic features, and/or embedding the code using techniques such as, for example, CodeBERT.
Step 2—Train Individual Models—with multiple models, the ML systems 30, 40 may ensure that each model is trained effectively, such as by using:
a) Diverse Models-Use a range of models that might include traditional ML (e.g., SVMs, decision trees, etc.) and deep learning approaches (e.g., CNNs, RNNs for sequential data-like code),
b) Training Data-Ensure each model is trained on a diverse dataset that includes code samples from both developers and GenAI sources, labeled appropriately, and
c) Feature Selection-Depending on the model, the ML systems 30, 40 may select different features that could include lexical, syntactic, and semantic aspects of the code.
Step 3—Model Joining—After training individual models, the ML systems 30, 40 may combine their predictions to improve accuracy. This may include:
a) Voting Scheme—Use a simple majority vote, where the final classification is based on the most common prediction across all models,
b) Weighted Voting—If some models are more accurate than others, the ML systems 30, 40 may assign more weight to their predictions, and
c) Stacking-Training a meta-model that takes the predictions of all of the individual models as inputs and provides an output of a final prediction. This approach may allow for capturing the relationships between model predictions.
Step 4—Interpret the Results—This may include obtaining:
a) Confidence Scores—Assess the confidence scores of the predictions to understand a certainty level at which the joint model can decide, and
b) Error Analysis—Examine cases where the joint model makes incorrect predictions to identify patterns or biases in the models.
Step 5—Continuous Improvement—This may include:
a) Feedback Loop—Incorporate new code samples into the training set, especially those where the ability of the joint model to predict was incorrect or the confidence was low, and
b) Model Reevaluation—The ML systems 30, 40 can periodically reevaluate the models and perform a joining or ensemble strategy to incorporate new developments in ML and changes in coding practices.

In this respect, there may be certain additional technical considerations in this embodiment. For example, with respect to model transparency, the ML systems 30, 40 can be configured to understand the decision-making process, especially for complex models. The ML systems 30, 40 may use techniques like SHapley Additive explanations (SHAP) or other suitable techniques. Also, there may be certain ethical and privacy concerns to consider, which may be developed into the ML systems 30, 40. For example, it may be proper to ensure that the various approaches respect the privacy and intellectual property rights of developers whose code samples are being tested and analyzed. These approaches may combine the strengths of individual models and may mitigate their weaknesses, potentially leading to a more accurate system for distinguishing between developer-generated and GenAI-generated code.

According to another implementation, the ML systems 30, 40 may train one model on code written by a developer and another model on code generated by GenAI. With a new code sample, the ML systems 30, 40 may determine if it was written by the developer or generated by the GenAI. Given that the ML systems 30, 40 have one model trained on code written by a developer and another trained on code generated by GenAI, the ML systems 30, 40 may be configured to classify a new code sample following a comparative analysis approach. For example, this may include:
Step 1—Preprocess the New Code Sample, such as by normalizing the code to ensure the new code sample is preprocessed in the same way as the training data was for both models. This may include tokenization, formatting standardization, feature extraction, and/or embedding techniques used during training.
Step 2—Evaluate the Code Sample with Both Models, which may include:
a) Model Predictions—Feed preprocessed code samples into both models separately. If the models are trained for classification, the ML systems 30, 40 can output a probability score or confidence level indicating how similar the sample is to the data they were trained on.
b) Interpret Scores—Each model may provide a score reflecting how closely the new code matches its training data. For instance, the model trained on developer code might output a high score if the new code closely resembles human-written code, indicating similarity to developer-written code. Conversely, the model trained on GenAI-generated code may score it based on its resemblance to GenAI patterns.
Step 3—Decision Rule, which may include:
a) Direct Comparison—The ML systems 30, 40 may compare the scores from both models. For example, the model that gives a higher confidence score to the code sample may be considered as being similar to its training dataset, which may indicate the origin of the new code.
b) Thresholds—The ML system 30, 40 may set a threshold for decision-making. For example, if both models give a score above a certain confidence level, the decision could be based on which score is higher. If neither reaches the threshold, the sample might be deemed too ambiguous without further analysis.
Step 4—Interpret with Caution, which may include:
a) Consider Overlaps and Limitations—The ML system 30, 40 may be configured to be aware that there might be overlaps in the styles of code generated by a developer and GenAI, especially if the GenAI was trained on code similar to that of the developer. In some situations, the distinction may not always be clear-cut.
b) Model Limitations—Each model's performance may depend on its training data, architecture, and the features it learned. It may be possible for both models to misclassify a code sample if it contains elements they were not adequately trained to recognize. In this case, upon analysis by a user, additional training data may be provided to the ML systems 30, 40.

In this embodiment, there may be additional considerations. For example, the ML system 30, 40 may be configured for continuous learning. That is, if possible, the ML systems 30, 40 can use various evaluations as feedback to improve the models. This may include incorporating new samples and their evaluations back into the training set to refine the accuracy of the models over time. Also, in some implementations, it may be viable solution, if binary approach has limitations, that the ML systems 30, 40 are configured to train a single model using a mixed dataset labeled with the source of each code sample (i.e., developer vs. GenAI). This approach may potentially lead to a more nuanced understanding and classification capability.

### Method for Predicting the Source of Digital Content

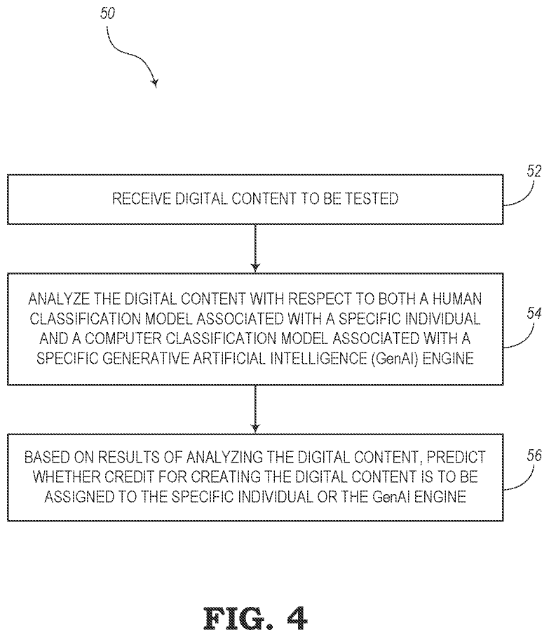

FIG. 4 is a flow diagram illustrating an embodiment of a method 50 for predicting a source of digital content and assigning credit for creating the digital content. As shown in this embodiment, the method 50 includes a step of receiving digital content to be tested, as indicated in block 52. The method 50 further includes a step of analyzing the digital content with respect to both a human classification model associated with a specific individual and a computer classification model associated with a specific Generative Artificial Intelligence (GenAI) engine, as indicated in block 54. Also, based on results of analyzing the digital content, the method 50 further includes a step of predicting whether credit for creating the digital content is to be assigned to the specific individual or the GenAI engine, as indicated in block 56.

According to some embodiments, the step of predicting whether credit for creating the digital content (block 56) may include a step of determining whether a source of “consequential” portions of the digital content is to be credited to the specific individual or the GenAI engine. That is, irrelevant background templates and boilerplate data may be disregarded. The step of predicting (block 56) may also include, in some embodiments, a step of determining “portions” (e.g., percentages, amounts, etc.) of the digital content that are credited to the specific individual and/or GenAI engine. The method 50 may further include a step of providing an output including details of a prediction associated with the step of predicting (block 56) whether credit for creating the digital content is to be assigned to the specific individual or the GenAI engine. In some embodiments, the details of the prediction may be based on the consequential portions, as well as an identification of what is considered to be consequential, plus an amount (or portion or percentage) of the credited content.

In some embodiments, the digital content described in the method 50 may refer to software code. In this case, the step of training the human classification model (block 54) may be performed, for example, by learning programming habits, styles, patterns, syntax, function generation techniques, and human-readable comments of the specific individual (e.g., programmer) from samples of software code obtained from an Integrated Development Environment (IDE) associated with the specific individual or programmer.

The human classification model may be trained, according to some implementations, with respect to a group of collaborating individuals. Also, the computer classification model may be trained with respect to a group of GenAI engines. In some embodiments, the method 50 may further includes steps of a) training a plurality of human classification models respectively associated with a plurality of individuals, and b) training a plurality of computer classification models respectively associated with a plurality of GenAI engines. Also, the method 50 may include steps of a) training the human classification model based on one or more digital content samples verified as being created by the specific individual, and b) training the computer classification model based on one or more digital content samples verified as being created by the specific GenAI engine.

In some implementations, the method 50 may also include steps of a) receiving a first set of label information associated with the specific individual for supervised training of the human classification model, and b) receiving a second set of label information associated with the specific GenAI engine for supervised training of the computer classification model. Also, the step of predicting whether credit for creating the digital content is to be assigned to the specific individual or the GenAI engine (block 56) may include the utilization of a Machine Learning (ML) engine encoded with the human classification model and computer classification model. According to various embodiments, the digital content described herein may include videos, photographs, artwork, Non-Fungible Tokens (NFTs), digital assets, music, news, literary works, and/or other similar types of data.

### Use Cases

1. Trust—it can be difficult to know if code is being drafted by GenAI or a software developer. Many developers may work remotely these days while collaborating with other developers (e.g., using GitLab, GitHub, Bitbucket, or other Repo Asset Management tools). For example, in GitHub, a member of a repo may invite users to collaborate based on their GitHub user ID. However, this can become a trust issue when the identity of certain people within a collaboration group may be unknown.
2. New developers—in a hiring scenario, a company may test a new software developer by giving them some tasks and analyzing their code. However, once a person is hired, management may discover that the newly hired person is unable to actually code. Instead, it may be determined that they had used some tool, such as MS Copilot to generate the test. This situation, for example, may also be applicable in a school setting where an instructor gives an assignment to the class, but it is unknown if each student actually performs their own coding.
3. Merger and Acquisitions (M&A)—when buying a company, the acquiring party may ask several questions to find out the value of the company to be purchased. However, they may not get clear answers to important questions, such as “How much of the code of program X was generated by developers of the company? And how much by generated by GenAI or another tool?” If much of the work had been computer-generated, then it may raise an issue as to the true value of the company and whether it would be worth it to acquire such a company.

Based on the above use cases, among others, the systems and methods of the present disclosure are configured to solve the above problems via specific approaches, such as:
a) training a model based on existing and future data generated by each individual. One example may include looking at previous code commits from each developer to get a base line of their programming approach,
b) training based on outputs generated by LLMs, such as Copilot for GitHub, and
c) creating a comparison method based on confidence models to compare the output for any repo (or data store) over a specific period of time.

### CONCLUSION

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. A system comprising:
a processing device; and
memory configured to store a program having logic instructions that, when executed, enable the processing device to perform steps of
receiving digital content to be tested,
analyzing the digital content with respect to both a human classification model associated with a specific individual and a computer classification model associated with a specific Generative Artificial Intelligence (GenAI) engine, and
based on results of analyzing the digital content, predicting whether credit for creating the digital content is to be assigned to the specific individual or the GenAI engine.

2. The system of claim 1, wherein the step of predicting whether credit for creating the digital content is to be assigned to the specific individual or the GenAI engine further includes a sub-step of determining whether a source of consequential portions of the digital content is to be credited to the specific individual or the GenAI engine.

3. The system of claim 1, wherein the step of predicting whether credit for creating the digital content is to be assigned to the specific individual or the GenAI engine further includes a sub-step of determining portions of the digital content that are credited to the specific individual and/or GenAI engine.

4. The system of claim 1, further comprising a step of providing an output including details of a prediction associated with the step of predicting whether credit for creating the digital content is to be assigned to the specific individual or the GenAI engine.

5. The system of claim 1, wherein the digital content includes software code.

6. The system of claim 5, further comprising a step of training the human classification model by learning programming habits, styles, patterns, syntax, function generation techniques, and human-readable comments of the specific individual from samples of software code obtained from an Integrated Development Environment (IDE) associated with the specific individual.

7. The system of claim 1, wherein the human classification model is trained with respect to a group of collaborating individuals, and wherein the computer classification model is trained with respect to a group of GenAI engines.

8. The system of claim 1, further comprising steps of
training a plurality of human classification models respectively associated with a plurality of individuals, and
training a plurality of computer classification models respectively associated with a plurality of GenAI engines.

9. The system of claim 1, further comprising steps of
training the human classification model based on a first set of one or more digital content samples verified as being created by the specific individual, and
training the computer classification model based on a second set of one or more digital content samples verified as being created by the specific GenAI engine.

10. The system of claim 1, further comprising steps of
receiving a first set of label information associated with the specific individual for supervised training of the human classification model, and
receiving a second set of label information associated with the specific GenAI engine for supervised training of the computer classification model.

11. The system of claim 1, wherein the step of predicting whether credit for creating the digital content is to be assigned to the specific individual or the GenAI engine includes utilizing a Machine Learning (ML) engine encoded with the human classification model and computer classification model.

12. The system of claim 1, wherein the digital content includes one or more of videos, photographs, artwork, Non-Fungible Tokens (NFTs), digital assets, music, news, and literary works.

13. A non-transitory computer-readable medium configured to store a contribution differentiating program having computer logic with instructions for enabling one or more processing devices to execute steps of:
receiving digital content to be tested;
analyzing the digital content with respect to both a human classification model associated with a specific individual and a computer classification model associated with a specific Generative Artificial Intelligence (GenAI) engine; and
based on results of analyzing the digital content, predicting whether credit for creating the digital content is to be assigned to the specific individual or the GenAI engine.

14. The non-transitory computer-readable medium of claim 13, wherein the step of predicting whether credit for creating the digital content is to be assigned to the specific individual or the GenAI engine further includes enabling the one or more processing devices to execute one or more sub-steps of:
determining whether a source of consequential portions of the digital content is to be credited to the specific individual or the GenAI engine, and
determining portions of the digital content that are credited to the specific individual and/or GenAI engine.

15. The non-transitory computer-readable medium of claim 13, wherein the instructions further enable the one or more processing devices to execute a step of providing an output including details of a prediction associated with the step of predicting whether credit for creating the digital content is to be assigned to the specific individual or the GenAI engine.

16. The non-transitory computer-readable medium of claim 13, wherein the digital content includes software code, and wherein the instructions further enable the one or more processing devices to execute a step of training the human classification model by learning programming habits, styles, patterns, syntax, function generation techniques, and human-readable comments of the specific individual from samples of software code obtained from an Integrated Development Environment (IDE) associated with the specific individual.

17. A method comprising steps of:
receiving digital content to be tested;
analyzing the digital content with respect to both a human classification model associated with a specific individual and a computer classification model associated with a specific Generative Artificial Intelligence (GenAI) engine; and
based on results of analyzing the digital content, predicting whether credit for creating the digital content is to be assigned to the specific individual or the GenAI engine.

18. The method of claim 17, further comprising steps of:
training a plurality of human classification models, each human classification model being associated with one individual or a group of collaborating individuals, each human classification model trained on one or more digital content samples verified as being created by the one individual or group of collaborating individuals, and each human classification model being further trained with supervised label information, and
training a plurality of computer classification models respectively associated with a plurality of GenAI engines, each computer classification model trained on one or more digital content samples verified as being created by the respective GenAI engine, and each computer classification model being further trained with supervised label information.

19. The method of claim 17, wherein the step of predicting whether credit for creating the digital content is to be assigned to the specific individual or the GenAI engine includes utilizing a Machine Learning (ML) engine encoded with the human classification model and computer classification model.

20. The method of claim 17, wherein the digital content includes one or more of videos, photographs, artwork, Non-Fungible Tokens (NFTs), digital assets, music, news, and literary works.
